(19) United States
(12) Patent Application Publication
(10) Pub. No.: US 2005/0170731 A1
(43) Pub. Date: Aug. 4, 2005

(54) Fibrous structure which is used to produce composite materials

(75) Inventors: Michel Droux, La Ravoire (FR); Francois Roederer, Chambery (FR); Francois Vinet, Chambery (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT GOBAIN VETROTEX FRANCE S.A., Chambery (FR)

(21) Appl. No.: 10/500,468

(22) PCT Filed: Jan. 15, 2003
(86) PCT No.: PCT/FR03/00111

(30) Foreign Application Priority Data
Jan. 16, 2002 (FR) 02/00468

(51) Int. Cl. B32B 5/26

(52) U.S. Cl. 442/381; 442/327; 442/387; 428/102; 428/103

(57) ABSTRACT

The invention relates to a fibrous structure, especially made of glass, comprising at least one layer of randomly distributed continuous strands and at least one reinforcing fabric layer, such as a chopped strand layer, the various layers of the structure being linked together by a mechanical means, such as stitching or needle punching, and/or a chemical means, such as a binder. This structure may be produced continuously or in a batch process. It has good permeability and good deformability when it is used to produce a composite.

The invention relates to a fibrous structure comprising at least two layers, more particularly to a structure that can be used to manufacture composites.

The production of a fiber-reinforced composite includes the step of forming a fibrous structure in a mold followed by the injection of a polymer-based resin in order to impregnate the fibrous structure. The resin then solidifies, by crosslinking (in the case of thermosetting resins) or on cooling (in the case of thermoplastic resins). The fibrous structure must consequently have a number of properties, and especially the following:
before impregnation, it must be able to be formed easily, and therefore must be readily deformable especially by hand;
it must be able to be impregnated as easily as possible and must therefore be as permeable as possible to the impregnation resin; and
it must reinforce the final material as much as possible.

The use of crimped polypropylene fibers has been proposed in EP 0 745 716, EP 0 659 922 and EP 0 395 548 for making fibrous reinforcing structures. However, for a number of applications, the reinforcing properties of polypropylene fiber are insufficient and said fiber is also not easily wetted and impregnated by resins such as polyesters. The use of other fibers having superior mechanical properties and being able to be impregnated better is therefore desirable. Moreover, it is also desirable to be able to use uncrimped fibers, recognizing the fact that the production of a crimp represents an additional step and also that it is not always possible to produce a crimp in a fiber, especially a glass fiber.

WO 96/27039 discloses a reinforcing structure comprising a central web of a nonwoven or of a knit made of glass fiber. However, the Applicant has discovered that knits and nonwovens of the chopped-strand mat type have a low permeability to the impregnation resin. Furthermore, a glass knit does not allow very lightweight structures to be produced.

As other documents of the prior art, mention may also be made of WO 96/13627 and EP 0 694 643.

Within the context of the present invention, the term “mat” refers to a bonded nonwoven. Such a mat has enough cohesion for it to be able to be handled manually, without losing its structure. It possesses such cohesion because it is bonded, generally by chemical means (use of a chemical binder) or by mechanical means, such as needle punching or stitching.

The fibrous structure according to the invention solves the abovementioned problems. The fibrous structure according to the invention comprises at least one layer of randomly distributed continuous strands and at least one reinforcing fabric layer, the various layers of the structure being linked together by a mechanical means or a chemical means.

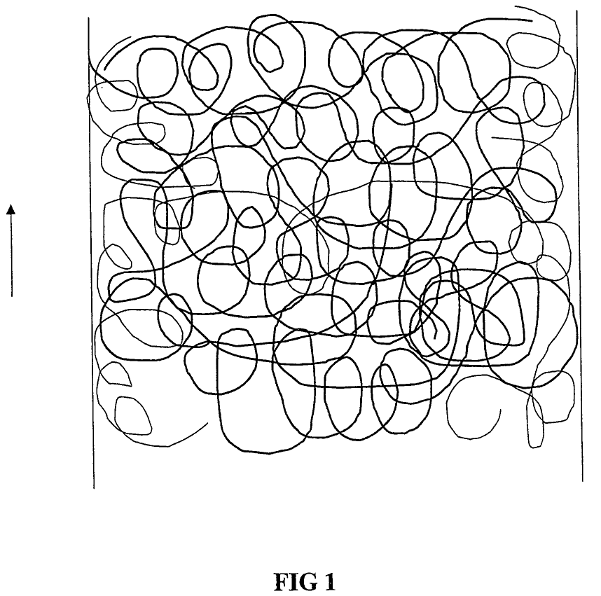

The continuous strand layer is formed from loops of continuous strands partially superposed one on top of another. This layer is intended to give the entire structure its thickness and deformability. It is deformable and permeable to the resins normally used in the manufacture of composites. In general, the various loops derive from a large number of strands, for example 80 to 600 strands. Such a structure can be seen in FIG. 1. This structure in FIG. 1 is produced with a few (only five or six) continuous strands. The arrow on the left indicates the direction in which the layer runs during its manufacture. FIG. 1 merely shows, in a simplified manner, the start of the formation of a continuous strand layer, so as to illustrate the shape of the loops. In fact, the layer, when it has been completed, usually comprises so many loops that it is no longer possible to see through it. This is especially the case when it has a mass per unit area of 450 g/m². The term “strand” is understood to mean an assembly of contiguous filaments, comprising more particularly from 10 to 300 filaments. In general, this layer has a mass per unit area ranging from 200 to 700 g/m² and more particularly from 350 to 550 g/m², especially about 450 g/m². Advantageously, the continuous strand layer is made of glass, giving it substantial reinforcing properties. As continuous glass strand layer, the material sold by Saint-Gobain Vetrotex under the brand name UNIFILO® may be used. This layer, whose essential function is to give thickness and to be permeable also has a reinforcing property. For the same grammage (i.e. mass per unit area), the structure according to the invention exhibits better permeability compared with the same structure in which the continuous strand layer is replaced with a chopped strand mat. The strands of the continuous strand layer generally have a length ranging from two meters to four times the total length of the structure that contains it.

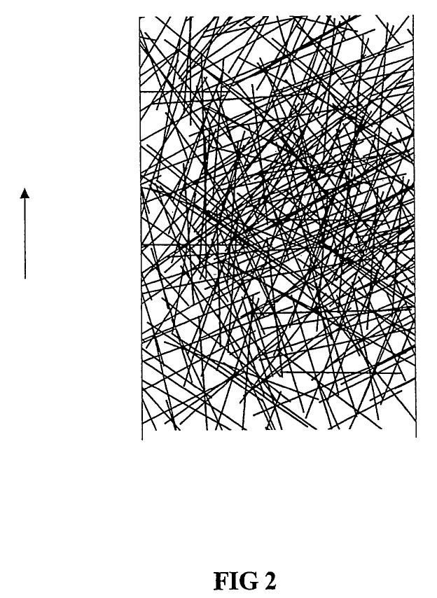

The reinforcing fabric layer comprises strands and may have any structure. It may be made of a nonwoven, chopped strands, chopped strand mat, a continuous strand mat, a woven or a unidirectional web. Preferably, the reinforcing fabric layer is made of chopped strands. These chopped strands may, for example, have a length ranging from 1 to 15 cm. Generally, this reinforcing layer has a mass per unit area ranging from 100 to 600 g/m² and more particularly from 200 to 400 g/m², for example about 300 g/m². FIG. 2 shows a low-density chopped strand layer seen from above. The arrow on the left indicates the direction in which the layer runs.

The structure according to the invention preferably comprises a central continuous strand layer placed between two reinforcing fabric layers. In this case, the structure according to the invention comprises a second reinforcing fabric layer located on the other side of the continuous strand layer in relation to the first reinforcing fabric layer. These two reinforcing fabric layers may be identical or different.

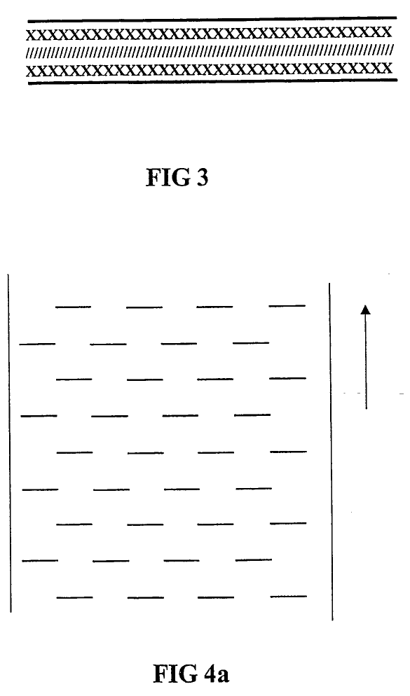

Particularly when the structure according to the invention comprises a chopped strand layer as reinforcing fabric layer, said structure may also include a layer of a veil lying on the reinforcing layer, on the other side from that of the continuous strand layer relative to the reinforcing fabric layer. This veil may form at least one of the two external faces of the structure. The structure may also comprise two veils. This may especially be the case when the structure according to the invention comprises a central continuous strand layer placed between two reinforcing fabric layers. In this case, the structure according to the invention may comprise two veil layers, each forming one of the two external layers of the structure. The structure then comprises two veils, each forming the two external faces of the structure. Such a structure is shown in cross section in FIG. 3 (in this case, the symbols have the following meanings:
continuous strands: ////////////; chopped strands: XXXXX; veil: ______).

The term “veil” is understood to mean a nonwoven formed from completely dispersed filaments. This veil layer generally has a mass per unit area ranging from 10 to 60 g/m² and more particularly from 20 to 40 g/m², for example about 30 g/m².

Within the context of the present invention, it is possible to use a chemical means (also called a binder) to link various points inside the same layer of the structure and/or to link various points in different layers of the structure. In particular, the cohesion of the continuous strand layer may be increased by using a binder, independently of its association with the other layers of the structure. In this case, the binder binds the loops of the continuous strand layer and fixes the geometry of the continuous strand layer, thereby preventing this layer from becoming flattened during impregnation. This therefore prevents an effect in which the strands making up this layer move during impregnation which could make impregnation very difficult at a certain moment during impregnation. It is in this sense that the use of a binder increases the permeability of the structure to the impregnation resin. A continuous strand layer thus bonded can then be called a continuous strand mat.

The binder may be used in liquid form (which includes a solution, emulsion or suspension), deposited by a device of the cascade or spray type, or in the form of a powder, deposited by a powder dispenser, or in the form of a film.

In general, the binder may be used in the form of a powder, which may be sprayed onto the layer or the structure to be bonded. When the function of the binder is to link various layers of the structure, it may also be used in the form of a film placed between the layers to be linked. A suitable heat treatment then melts and/or crosslinks a component of the binder so that it impregnates the various points that it has to link. If the binder comprises a thermoplastic polymer, the heat treatment melts this polymer so that it impregnates various regions of the structure, this resulting, on returning to room temperature, in strong bridges between the various points to be linked. If the binder comprises a thermosetting compound (especially a polymer), the heat treatment causes this compound to crosslink (if necessary after melting) so that it links, by strong bridges, the various regions to be linked. In both cases (thermoplastic binder or thermosetting binder), the heat treatment also serves to evaporate any solvent used for applying it. The chemical compound may be a polyester resin of the thermosetting or thermoplastic type. An acrylic polymer can be used as crosslinkable (thermosetting) binder.

The various layers of the structure according to the invention are linked together by mechanical and/or chemical means. The term “mechanical means” is understood to mean stitching or needle punching, stitching being preferred. The term “chemical means” is understood to mean a binder as mentioned above. The binder may bond the various fabric layers together in pairs. The binder may be used in the form of a powder or in the form of a liquid or in the form of a film interposed between the various layers of the structure. When a veil covers one or both reinforcing fabric layers, this veil or these veils are preferably bonded chemically (generally by an adhesive) to the structure, especially if it is preferred to avoid the presence on the surface of the structure of visible marks of mechanical bonding for aesthetic regions. Thus, the various non-veil layers may be bonded by stitching or needle punching, while the veil or veils forming one or both faces of the structure may be bonded to the structure by a binder.

If a binder has already been used to give the continuous strand layer cohesion, it is preferred to use a binder of the same nature to bond the various layers of the structure.

The entire final structure (ready to be used) may comprise 0.5 to 10% by weight of binder (after the heat treatment), including the binder possibly used to give the continuous strand layer cohesion. The continuous strand layer may comprise 1 to 5% by weight of binder (after the heat treatment) relative to its own weight.

If the various fabric layers of the structure are linked by stitching or needle punching, the loops of the continuous strand layer may in addition also be bonded together by a binder, no binder linking various fabric layers together.

If at least one reinforcing fabric layer comprises chopped strands and when the various fabric layers of the structure are linked by stitching or needle punching, it is furthermore possible for the chopped strands of said reinforcing fabric layer also to be bonded together by a binder, no binder linking various fabric layers together.

The strands used to produce the various layers of the structure according to the invention may be made of glass, carbon or aramid. Thus, the continuous strand layer may be made of glass; likewise, the reinforcing fabric layer may be made of glass. However, all the layers of the structure according to the invention may be made of glass strands. Generally, the glass strand that can be used is sized in a manner known by those skilled in the art. In particular, a glass strand sized to an amount of 0.04 to 3% by weight, and especially about 0.2% by weight, may be used to produce the continuous strand layer.

The structure according to the invention may be produced continuously or in a batch process.

A continuous production process may involve the following successive steps carried out on a moving belt:
production of a first chopped strand layer by depositing chopped strands on a moving belt; then
production of the continuous strand layer on the first chopped strand layer, by producing loops (directly from a bushing or from a roving); and then
production of a second chopped strand layer by depositing chopped strands on the continuous strand layer.

When appropriate, a veil may be deposited before the first chopped strand layer is produced. When appropriate, a veil may be deposited after the second chopped strand layer has been produced. The structure may therefore include two veils each placed on the external faces of the structure.

In this continuous process, the various layers of the structure may be combined by at least one mechanical means such as needle punching or stitching and/or at least one chemical means, such as a binder. In particular, all the layers of the structure may be linked together by needle punching or stitching. If one or two veils are used on one or both faces of the structure, all the other (non-veil) layers of the structure (especially the reinforcing fabric layer or layers and the continuous strand layer) may be linked together by needle punching or stitching and the veil layer or layers may be linked to the rest of the structure by adhesive bonding. In this case, the continuous strand layer and the reinforcing fabric layer(s) are combined beforehand by stitching or needle punching and the veil layer or layers is (are) then laminated onto the external faces of the structure, it being possible for all these operations to be carried out continuously.

In such a continuous process, although not excluded, it is not absolutely necessary to use a binder to form the bridging between the loops of the continuous strand layer. This is because needle punching or stitching gives the entire structure cohesion, so that the structure can be handled manually without any risk of it disintegrating. However, it is possible, in addition to needle punching or stitching, to also use a binder to bind together the loops of the continuous strand layer. To do this, all that is required is to apply the binder to the continuous strand layer before the second chopped strand layer is produced. In general, if it is desired to bind together only the loops of the chopped strand layer, the binder is applied by spraying. It may also be desirable to use a binder to bond the various layers of the structure in addition to needle punching or stitching. To do this, it is possible, for example, to spray the binder between the production of the various layers. It is also possible to use a binder in the form of a film, which is placed between the various layers of the structure to be bonded together.

It is also possible to use a binder to give the entire structure cohesion without the use of needle punching or stitching. This is because the binder not only fixes the geometry of the continuous strand layer, thereby preventing this layer from collapsing during impregnation, but also links pairwise the various layers of the structure. This prevents an effect in which the strands move during impregnation, which, on the one hand, could make impregnation very difficult at a certain moment during impregnation and, on the other hand, would make the final part nonuniform. It is for this reason that a binder is used, as it makes the structure more permeable to the impregnation resin. The binder may thus be sprayed in liquid form between the various layers or be applied in the form of a meltable film between the various layers. The heat treatment may be carried out on the entire structure so that there is only a single heat treatment to perform.

A batch production process may involve the separate production of the continuous strand layer in the form of a mat. To do this, the loops of the layer are firstly produced on a moving belt, the belt is then made to pass beneath a binder application unit (the binder generally being in liquid form), then the belt is made to pass through an oven so as to carry out the heat treatment, and then the continuous strand mat thus obtained is wound up to produce a roll. The continuous strand layer (bound together by the binder) may thus be stored in the form of a roll of a continuous strand mat. After storage, the roll may be taken up in a separate operation so that a continuous strand mat can then be inserted into the structure according to the invention.

In the case of a batch production process, the reinforcing fabric layer may also be produced separately as a roll, which may be taken up in a subsequent operation so that said layer is inserted into the structure according to the invention.

Thus, in the case of a batch process, when two chopped strand layers are combined with the continuous strand layer, one on either side of the continuous strand layer, the procedure may be, for example, as described below:
production of a first chopped strand layer by depositing chopped strands on a moving belt or by unwinding a roll of chopped strand mat; then
production of the continuous strand layer on top of the first chopped strand layer by producing loops (directly from a bushing or form a roving) or by unwinding the continuous strand layer from a roll of mat, continuously because of the fact that the belt continues to run; and then
production of a second chopped strand layer on the continuous strand layer by depositing chopped strands or by unwinding a roll of chopped strand mat, this step being carried out continuously because of the fact that the belt continues to run.

When appropriate, a veil may be deposited before the first chopped strand layer has been produced. When appropriate, a veil may be deposited after the second chopped strand layer has been produced. The structure may therefore include two veils, each placed on the external faces of the structure.

In this batch process, the various layers of the structure may be combined by at least one mechanical means, such as needle punching or stitching and/or at least one chemical means, such as a binder. In particular, all the layers of the structure may be linked together by needle punching or stitching. If one or two veils are used on one or both faces of the structure, all the other (non-veil) layers of the structure (especially the reinforcing fabric layer or layers and the continuous strand layer) may be linked together by needle punching or stitching and the veil layer or layers may be linked to the rest of the structure by adhesive bonding. In this case, the continuous strand layer and the reinforcing fabric layer(s) are combined beforehand by stitching or needle punching, and the veil layer(s) is (are) then laminated onto the external faces of the structure.

Within the context of this batch process, it is also possible to use a binder to give the entire structure cohesion without the use of needle punching or stitching. This is because the binder links pairwise the various layers of the structure. This prevents an effect in which the strands move during impregnation, which could make impregnation very difficult at a certain moment during impregnation. It is for this reason that a binder is used, as it makes the structure more permeable to the impregnation resin. The binder may thus be sprayed in liquid form between the various layers or be applied in the form of a meltable film between the various layers. The heat treatment to be carried out because of the binder intended to link the various layers of the structure together may be carried out on the entire structure once the various fabric layers have been superposed.

Notches may be produced through the continuous strand layer so as to increase its deformability. These notches may have any direction relative to said layer. These notches are produced by knives which cut the continuous strand layer right through its thickness or through only part of its thickness, generally without removing material. They have a limited length, which may range from 0.01 to 0.35 times the width of the continuous strand layer. The continuous strand layer has, like the structure according to the invention, a thickness, a width and a length. The width of the continuous strand layer is the smallest dimension of the layer in the plane of the continuous strands. Preferably the direction of the notches is that of the width. Thus, if the continuous strand layer is intended to be wound up in mat form, the notches have the same direction as the axis of the roll of the continuous strand layer. The notches thus make it easier to wind up the layer, by making it less rigid in the direction of winding. However, it is also possible to wind up the continuous strand layer without notches, notches being produced at the moment when it is unwound, just before the structure according to the invention is produced. In either case, the presence of notches makes it easier to wind up the structure according to the invention.

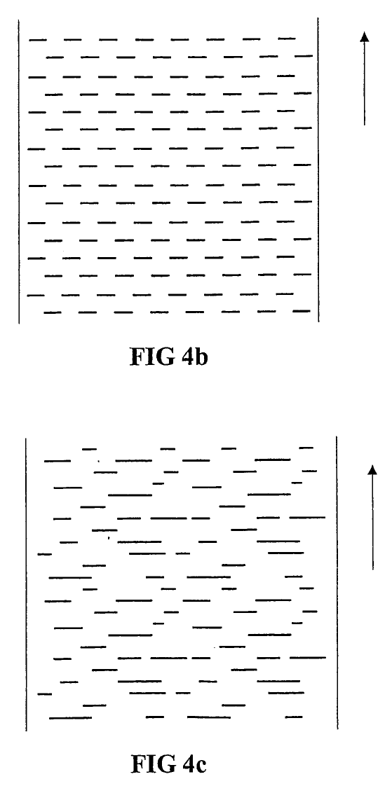

The notches may, for example, each have a length ranging from 0.5 to 30 cm. The notches may, for example, be present in an amount of 30 to 200 notches per m² of continuous strand layer. For example, 100 such notches per m² of continuous strand layer may be produced. FIG. 4 shows a top view of a continuous strand layer provided with mutually parallel notches having the direction of the width of the layer. Various notch configurations are shown in FIGS. 4a, 4b and 4c. The notches may have different lengths for the same continuous strand layer, as shown in FIG. 4c. The arrows in the figures indicate the direction in which the layer is unwound.

By varying the amount of binder and the number and length of the notches, it is possible to vary the stiffness of the continuous strand layer. It is therefore possible, using notches, to compensate for the high stiffness that a large amount of binder give the continuous strand layer. By increasing the number of notches, it is therefore possible to use a large amount of binder, thereby better fixing the geometry of the layer during impregnation. This is because it has been found that there is no drawback from the resin impregnation standpoint when there are notches (no packing effect, as explained above).

The structure according to the invention can be easily placed in an impregnation mold, by manually deforming it. This is easy to do because of the deformability of the continuous strand layer and thanks to the possible sliding of the various layers over one another within the same structure. The needle punching or stitching linking the various layers of the structure together allows such sliding to take place. The structure according to the invention can be easily impregnated since the resin retention time during impregnation is particularly short. The impregnability of the structure can be assessed using the following permeability test:
A flat piece is produced by resin transfer molding (RTM) in a mold equipped with pressure sensors. By placing these pressure sensors at regular intervals, graphs of the pressure as a function of time are obtained. Darcy's law is then applied, so as to obtain the permeability k in m², the permeability being given by the equation (Darcy's law):
   Q/s=k.ΔP/η.Δx
   in which:
Q represents the flow rate;
S represents the cross section of the mold impression;
η represents the dynamic viscosity of the impregnation resin;
ΔP represents the pressure difference between two sensors;
Δx represents the distance between two sensors.
Small values of k indicate a low permeability (or a high resistance to flow), large values indicate a high permeability (or a low resistance to flow).

The invention also relates to the composites that can be obtained by impregnating the structure according to the invention. This structure may in particular be impregnated by the processes referred to as RTM (Resin Transfer Molding) or SCRIMP (Seeman Composite Resin Infusion Molding Process). These processes are well known to those skilled in the art.

To impregnate the structure according to the invention, a resin of the following type is generally used: unsaturated polyester, phenolic, acrylic, epoxy or vinyl ester.

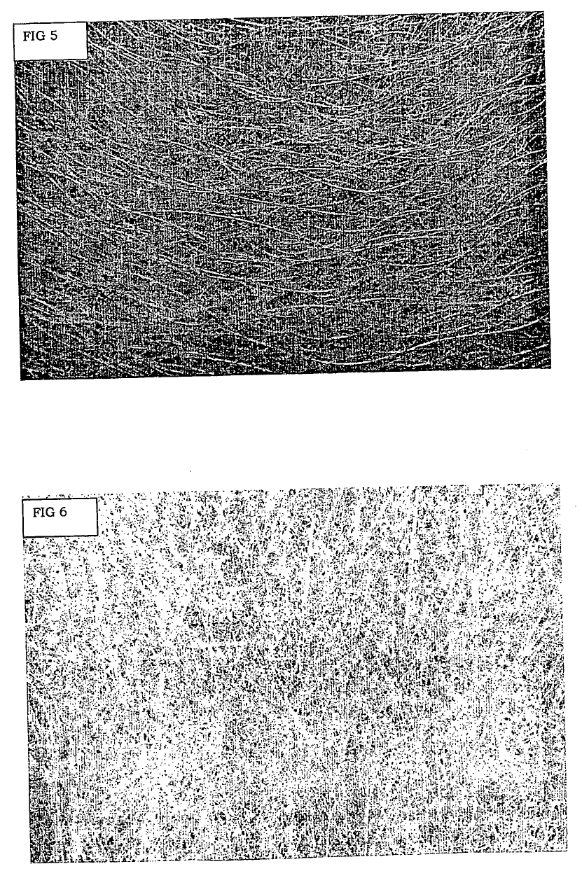

FIG. 5 shows a photograph of a continuous strand layer having a mass per unit area of about 450 g/m². FIG. 6 shows a photograph of a chopped strand layer having a mass per unit area of about 450 g/m².

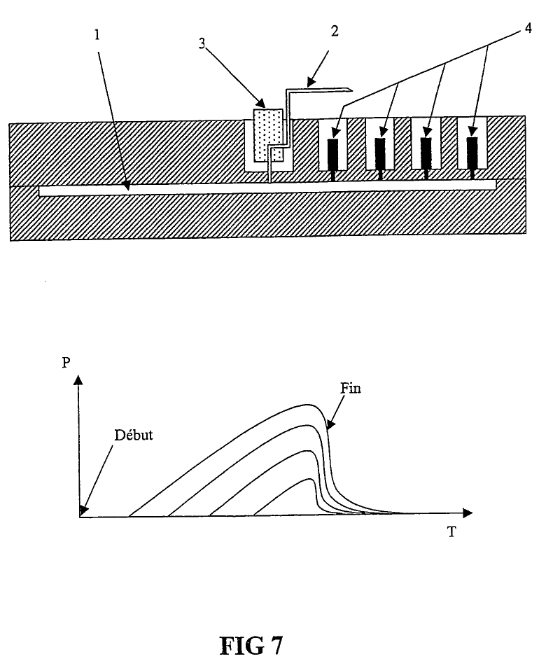

FIG. 7 shows, at the top, the apparatus that can be used for the permeability test and, at the bottom, the curves that can be obtained by monitoring the change in pressure P over time T. The apparatus comprises a mold 1 suitable for impregnating a flat structure by injecting a resin fed in via a line 2 to an injection head 3. The pressure sensors 4 measure the pressures in the mold.

1-26. (canceled)

27. A fibrous structure comprising:
at least one layer of randomly distributed continuous strands; and
at least one reinforcing fabric layer, the layers of the structure being linked together by a mechanical mechanism or a chemical mechanism.

28. The structure as claimed in claim 27, wherein the continuous strand layer has a mass per unit area ranging from 200 to 700 g/m².

29. The structure as claimed in claim 28, wherein the continuous strand layer has a mass per unit area ranging from 350 to 550 g/m².

30. The structure as claimed in claim 27, wherein the reinforcing fabric layer comprises chopped strands.

31. The structure as claimed in claim 30, wherein the reinforcing fabric layer has a mass per unit area ranging from 100 to 600 g/m².

32. The structure as claimed in claim 31, wherein the reinforcing fabric layer has a mass per unit area ranging from 200 to 400 g/m².

33. The structure as claimed in claim 30, wherein the chopped strands have a length ranging from 1 to 15 cm.

34. The structure as claimed in claim 27, further comprising:
a second reinforcing fabric layer, located on another side of the continuous strand layer from the first reinforcing fabric layer.

35. The structure as claimed in claim 34, further comprising:
at least one fleece forming at least one of two external faces of the structure.

36. The structure as claimed in claim 35, wherein the at least one fleece has a mass per unit area ranging from 10 to 60 g/m².

37. The structure as claimed in claim 36, wherein the at least one fleece has a mass per unit area ranging from 20 to 40 g/m².

38. The structure as claimed in claim 27, wherein non-fleece fabric layers are bound together by stitching.

39. The structure as claimed in claim 27, wherein non-fleece fabric layers are bound together by needle punching.

40. The structure as claimed in claim 27, wherein loops of the continuous strand layer are bound together by a binder.

41. The structure as claimed in claim 27, wherein the fabric layers are bound together pairwise by a binder.

42. The structure as claimed in claim 27, wherein the continuous strand layer includes notches for increasing its deformability.

43. The structure as claimed in claim 42, wherein the notches have a length ranging from 0.01 to 0.35 times a width of the continuous strand layer.

44. The structure as claimed in claim 43, wherein a direction of the notches is that of a width of the structure.

45. The structure as claimed in claim 42, wherein the notches have a length ranging from 0.5 to 30 cm.

46. The structure as claimed in claim 42, wherein the notches are present in an amount from 30 to 200 notches per m² of the continuous strand layer.

47. The structure as claimed in claim 27, wherein the continuous strand layer is made of glass.

48. The structure as claimed in claim 27, wherein the reinforcing fabric layer is made of glass.

49. A composite having a structure of claim 27.

50. A process for continuous production of a fibrous structure including at least one layer of randomly distributed continuous strands and two reinforcing fabric layers, the continuous strand layer being placed between the two reinforcing fabric layers, the process comprising:
producing a first chopped strand layer by depositing chopped strands on a moving belt; then
producing the continuous strand layer on the first chopped strand layer, by producing loops; and then
producing a second chopped strand layer by depositing chopped strands on the continuous strand layer,
the fabric layers of the structure then being linked together by at least one binder and/or at least one mechanical mechanism.

51. A process for batch production of a fibrous structure including at least one layer of randomly distributed continuous strands and two reinforcing fabric layers, the continuous strand layer being placed between the two reinforcing fabric layers, the process comprising:
producing a first chopped strand layer by depositing chopped strands on a moving belt or by unwinding a roll of chopped strand mat; then
producing the continuous strand layer on top of the first chopped strand layer by producing loops or by unwinding the continuous strand layer in a form of a mat from a roll, continuously as the belt continues to run; and then
producing a second chopped strand layer on the continuous strand layer by depositing chopped strands or by unwinding the roll of chopped strand mat, the producing the second chopped strand layer being carried out continuously as the belt continues to run,
the fabric layers of the structure then being linked together by at least one binder and/or at least one mechanical mechanism.

52. The process as claimed in claim 51, wherein the continuous strand layer is unwound in a form of a mat from a roll and includes notches.
